(19) United States
(12) Patent Application Publication
(10) Pub. No.: US 2014/0039979 A1
(43) Pub. Date: Feb. 6, 2014

(54) System and Method for Demand Forecasting

(71) Applicant: Opera Solutions, LLC, Jersey City, NJ (US)

(72) Inventors: Bo Zhang, San Diego, CA (US); Fei Tang, Shanghai (CN); Jun Wang, Shanghai (CN); Shoupeng Peng, New Taipei City (TW); Zhangle Wang, Shanghai (CN)

(73) Assignee: Opera Solutions, LLC, Jersey City, NJ (US)

(21) Appl. No.: 13/956,732

(22) Filed: Aug. 1, 2013

Related U.S. Application Data
(60) Provisional application No. 61/678,309, filed on Aug. 1, 2012.

(51) Int. Cl. G06Q 30/02

(52) U.S. Cl. CPC G06Q 30/0202
USPC 705/7.31

(57) ABSTRACT

A system and method for demand forecasting is provided. The system includes a computer system and a demand forecasting engine executed by the computer system. The demand forecasting engine permits inventory management and price optimization, with improved prediction accuracy. The system includes a nonlinear time series model which is able to simulate the market trend of a certain product in the past and make a demand forecast for the future. The system provides initial estimates for new products in a new season, and is self-adjusting with limited data points in the beginning of the season. In this way, the system provides solutions for demand forecasting of old and new products. Furthermore, pricing optimization solutions (e.g., Markov decision processed (MDP) based, etc.) can be built on the basis of the demand forecasting solutions. The system is applicable to many marketing-related problems and is particularly reliable for products which follow a certain cycle.

### CROSS-REFERENCE TO RELATED APPLICATION

This application claims priority to U.S. Provisional Patent Application No. 61/678,309 filed on Aug. 1, 2012, which is incorporated herein by reference in its entirety and made a part hereof.

### BACKGROUND OF THE INVENTION

1. Field of the Invention

The present invention relates generally to forecasting product demand for purposes of inventory management and price optimization. More specifically, the present invention relates to a system and method for demand forecasting.

2. Related Art

Businesses in various industries often face some significant problems with their products, such as out-of-stock issues for best sellers, over-stock issues for slow movers, etc. Often, manufacturers and retailers wish to know the optimal time and amount to discount each product in order to maximize revenues. Accurate demand forecasting for products, especially in the fields of inventory management and price optimization, is essential for a successful and competitive business.

Generally, there are some substantial constraints to implementing a demand forecasting solution. For instance, orders may have large lead times (e.g., purchase orders required months ahead of the start of sales), or a business may be limited in the number of supplemental orders that can be placed for seasonal items during the course of the season. Additionally, fashion and fashion-like goods do not usually have previous sales and demand records, even though some similarities can be found between different products of like items.

Although no demand forecasting method is completely accurate, solutions to improve demand forecasting accuracy generally combine quantitative and qualitative approaches. Quantitative forecasting methods include the “reference class” forecasting method which predicts the outcome of a planned action by looking at the actual outcomes of similar situations in the past (the reference class), and causal models which describe the causal relationships in a system. Qualitative approaches generally comprise judgment calls (e.g., educated guesses or expert opinion polls). In this way, it is not uncommon for purchasing decisions to be largely based on the past year's sales results and general intuition, so that pricing strategy and other factors are not fully considered. As such, there is a need for a system that is able to capture the time value of time-sensitive products and incorporate such information into demand forecasting to improve the accuracy thereof.

### SUMMARY OF THE INVENTION

The present invention relates to a system and method for demand forecasting. The system includes a computer system and a demand forecasting engine executed by the computer system. The demand forecasting engine permits inventory management and price optimization, with improved prediction accuracy. The system includes a nonlinear time series model which is able to simulate the market trend of a certain product in the past and make a demand forecast for the future. The system provides initial estimates for new products in a new season, and is self-adjusting with limited data points in the beginning of the season. In this way, the system provides solutions for demand forecasting of old and new products. Furthermore, pricing optimization solutions (e.g., using Markov decision processes (MDP), etc.) can be built on the basis of the demand forecasting solutions. The system is applicable to many marketing-related problems and is particularly reliable for products which follow a certain cycle.

### BRIEF DESCRIPTION OF THE DRAWINGS

The foregoing features of the invention will be apparent from the following Detailed Description of the Invention, taken in connection with the accompanying drawings, in which:

FIG. 1 is a diagram showing a general overview of the demand forecasting engine;

FIG. 2 is a flowchart showing processing steps carried out by the system for developing a time series model;

FIG. 3 is a graph visually depicting a trend function capable of being carried out by the system;

FIGS. 4-5 are graphs showing fitting results of a product sold during the summers of 2010 and 2011;

FIG. 6 shows the differing price strategies for the product of FIGS. 4-5 for the summers of 2010 and 2011;

FIG. 7 shows hypothetical previous, current, and estimated sales volumes;

FIG. 8 is a flowchart showing processing steps for carrying out a K-Nearest-Neighbor analysis to calculate a demand forecast for a new product; and

FIG. 9 is a diagram showing hardware and software components of a computer system capable of performing the processes of the present invention.

### DETAILED DESCRIPTION OF THE INVENTION

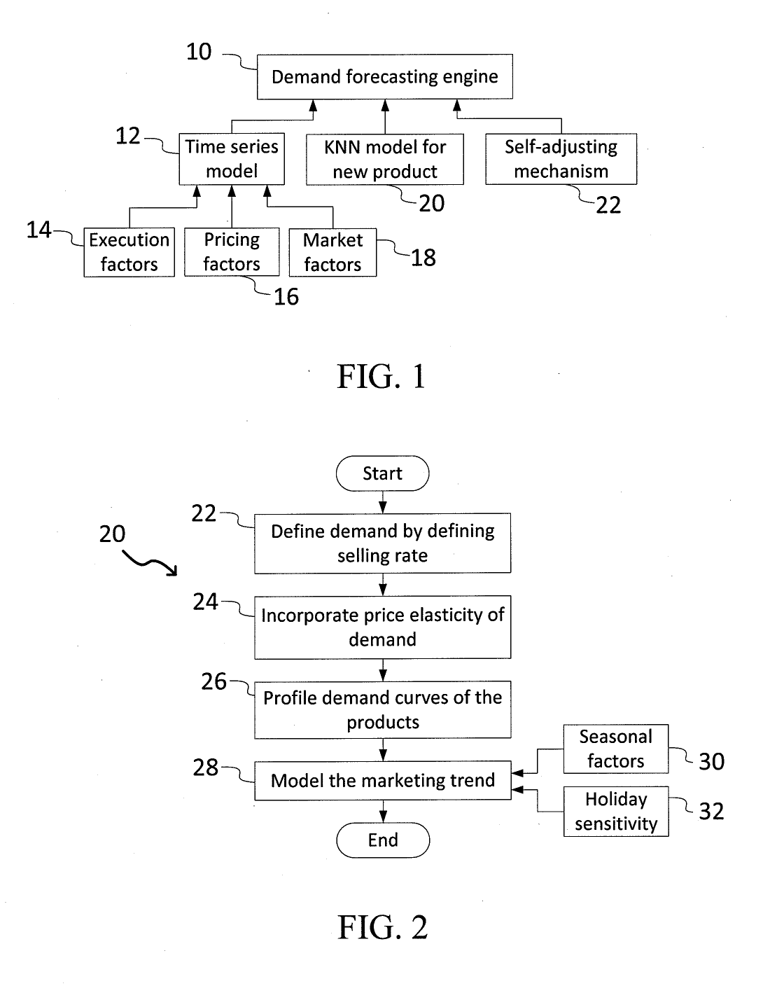

The present invention relates to a system and method for demand forecasting, as discussed in detail below in connection with FIGS. 1-9.

FIG. 1 is a diagram showing a general overview of the demand forecasting engine/module 10 of the present invention. As shown, the engine 10 incorporates a time series model 12 to simulate the market trend of a certain product, a K-Nearest-Neighbor (KNN) model 20 for demand forecasting of brand new products, and a self-adjusting mechanism 22. The time series model 12 is useful in situations where the time series of effective demand is available (e.g., accumulated sales data from past years of business in the market). The time series model 12 identifies a trend of time series data and makes a forecast by projecting the trend into the future. The basic assumptions of a time series model 12 are that there is information about the past, this information can be quantified in the form of data, and the pattern of the past will continue into the future. The engine 10 is adjustable depending on the needs of the user. For instance, if the prices of merchandise for a business are adjusted on a weekly basis, the smallest time unit used in the model is a week.

The time series model of a product's weekly sales volume depends on many factors, which can be grouped into execution factors 14, pricing/discount factors 16, and market factors 18. Execution factors 14 (e.g., on shelf time, off shelf time, number of shops where the product is on sale, when and where products are sold out, etc.) can be adjusted macroscopically in the following year, but are hard to quantify and predict. Pricing (discount) factors 16 are mainly determined by the price sensitivity of the product and can be quantified. The pricing strategy can also be planned and adjusted in real time. Market factors 18 (e.g., fashion trend, climate, time on sale, holidays, etc.) reflect the acceptance level of the consumers to the products, the change of the purchasing power, and the market saturation level. Market factors 18 vary with time and product so that different products might behave differently under the same circumstances. For example, sales of an essential product might be quite smooth throughout the whole year, while fashion products might be highly accepted for a short period of time in a market that is very small and subsequently saturated.

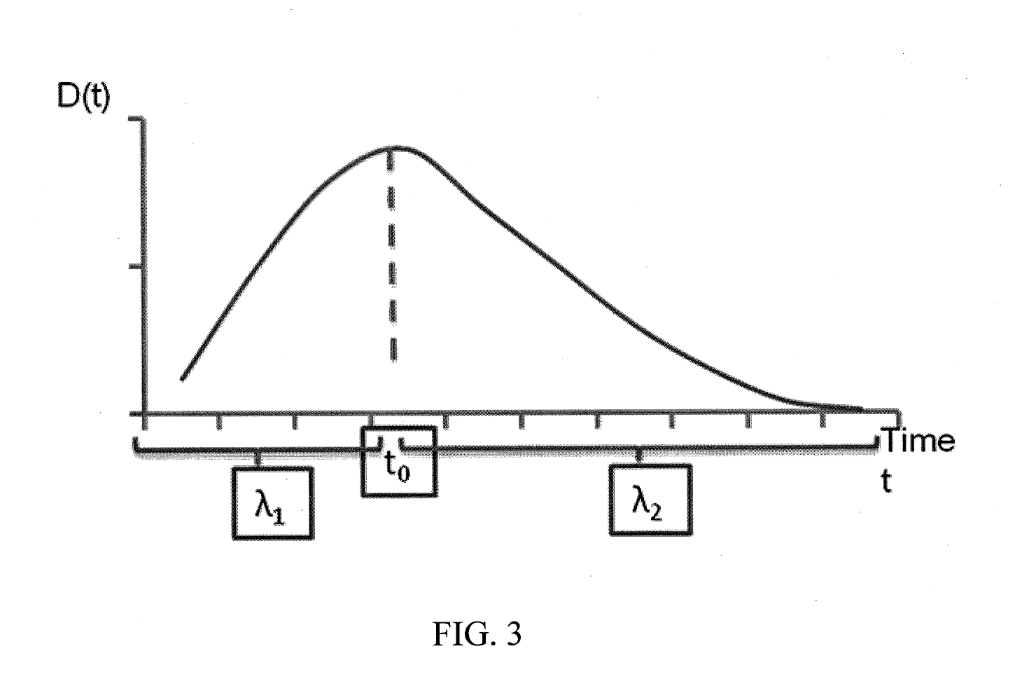

FIG. 2 is a flowchart 20 showing processing steps carried out by the engine 10 for developing a time series model. Starting in step 22, a quantity selling rate is defined to represent the demand in order to eliminate the influences from execution factors on sales volume. The selling rate (SR) of certain product within a given period is defined as the number of products sold per shop per day with stock:

$$\begin{matrix}Equation 1 & \\ S R = \frac{{\sum }_{s} {V}_{s}}{{\sum }_{s} {D}_{s}} & \end{matrix}$$

The index s represents all shops with this kind of product in stock, Vₛ is the sales volume of one of the shops in the given time period, and Dₛ is the number of days one of the shapes has the product in stock (i.e. flow days). In this way, the demand is only calculated based on flow days and the influence of stock-outs is reduced. Selling rates can be calculated for each product globally or by regions, and over various increments of time (weekly, monthly, yearly, etc.). Further, the selling rates of products with different coverage of shops can be compared directly. For example, if in a past season 1000 units of product 1 and 2000 units of product 2 were sold, product 2 would appear to be outperforming product 1. However, if product 1 was sold in 10 shops for 100 days, and product 2 was sold in 100 shops for 100 days, the selling rate of product 1 is 1000/(10*100)=1 and the selling rate of product 2 is 2000/(100*100)=0.2. This means product 1 actually sold faster than product 2, and therefore the demand for product 1 is larger than product 2.

In step 24, the price elasticity of demand is incorporated into the time series model. Price elasticity of demand (γ) is used to model different demands of the same product during the same season but at different prices. In other words, price elasticity measures the responsiveness of the demand to the change in price. More specifically, it is the percentage change in demand in response to one percent change in price. Price elasticity is determined by the characteristics of the good and its target population, and is related to demand through the following formula:

$$\begin{matrix}Equation 2 & \\ S R ∝ {( \frac{{p}_{0}}{p} )}^{- γ} & \end{matrix}$$

where p₀ is the original price, p is the current price of the product, and γ should always be negative for this equation.

In step 26, all of the demand curves of a business' products are then profiled for the years of interest. After profiling all of the demand curves, in step 28 the marketing trend is modeled by the system, taking into account seasonal factors 30 and holiday sensitivity 32. The marketing trend is modeled by function Q₀*D(t), where Q₀ is the selling rate constant (the maximum selling rate if sold at base price P₀ throughout the season), and D(t) is the trend function (the weekly trend of the product in the season), which is defined as:

$$\begin{matrix}Equation 3 & \\ \begin{matrix}D ( t ) = D ( {t}_{0} , {λ}_{1} , {λ}_{2} , t ) \\ = \{ \begin{matrix}{( 1 - {( \frac{{t}_{0} - t}{{λ}_{1}} )}^{3} )}^{3} & if {t}_{0} - {λ}_{1} \leq t < {t}_{0} \\ {( 1 - {( \frac{t - {t}_{0}}{{λ}_{2}} )}^{3} )}^{3} & if {t}_{0} \leq t < {t}_{0} + {λ}_{2} \\ 0 & if otherwise\end{matrix}\end{matrix} & \end{matrix}$$

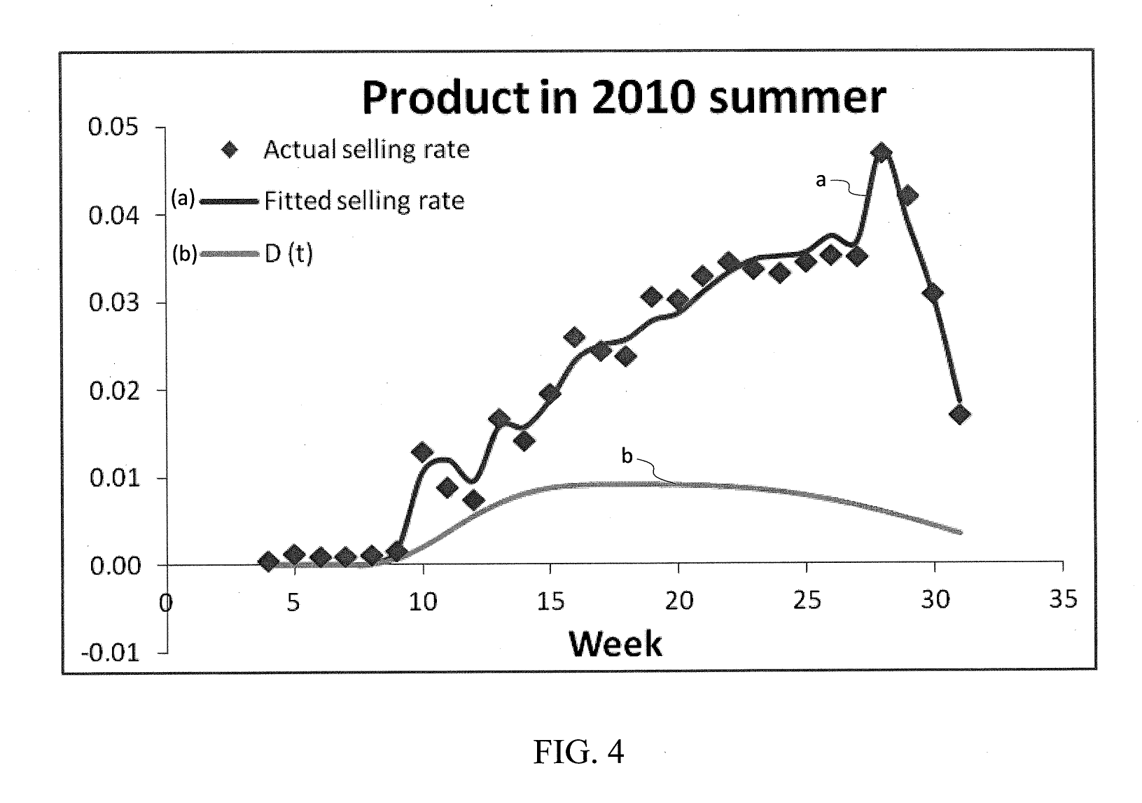

FIG. 3 is a graph visually depicting the trend function D(t) calculated by the present invention. The trend function takes into the account seasonal factors and describes how suitable the product is adapted to the weather and temperature of the season, and to what extent the product matches the fashion. The trend function also incorporates holiday sensitivity, which describes how sensitive the product is to holiday promotions. Sales volume is usually highly boosted during holidays but cannot be accounted for by price discounts alone because the spike is partly due to the increased customer flow and partly due to special holiday promotions launched by businesses. To model this kind of boost the following term is added to D(t):

$$\begin{matrix}Equations 4 and 5 & \\ D ( t ) ( 1 + s \times h ( t ) ) & ( 4 ) \\ h ( t ) = \{ \begin{matrix}{e}^{- \vert t - {t}_{h} \vert} & if t \leq {t}_{h} \\ {e}^{- \sqrt{\vert t - {t}_{h} \vert}} & if t > {t}_{h}\end{matrix} & ( 5 )\end{matrix}$$

where tₕ is the time of the holiday and s is the holiday sensitivity. More specifically, s is the percentage increase of the demand over the holiday compared with the demand if it is not holiday (e.g., s=1 means that the demand will increase by 100% during the holiday).

Further, there is usually more than one holiday in a sales season, and boosts to demands are typically not the same due to the different number of holiday days and different promotion plans (e.g., the boost of Holiday A to the demand could be much larger than that of Holiday B). Assuming that the holiday sensitivity s of a product is intrinsic (like price elasticity), another quantity, eₕ, is introduced to describe the scale of the boost of the holiday to the demand:

D(t)(1+s×Σ_{holidays}eₕh(t)) Equation 6

The actual holiday sensitivity of a product to a given holiday is determined by s* eₕ together, where s is a product-intrinsic parameter that can be learned from the data, and eₕ is a quantity specific to holidays and promotion plans that can be estimated beforehand from experience. For example, if a business will launch a special promotion in the current year for Holiday A, but saw no boost in demand in previous years (e.g., Holiday A recently became a public holiday), s*eₕ for Holiday A and Holiday B could be represented as 0.25 and 1, respectively. Note that it is the relative values of eₕ that matter instead of their absolute values since the actual sensitivity is determined jointly by s and eₕ (e.g., eₕ(Holiday A)=0.5 and eₕ(Holiday B)=2 so that s would be half the value as in the previous example).

Combining all of the factors, the time series model 12 is modeled as:

$$\begin{matrix}Equation 7 & \\ S R ( t , p ) = {Q}_{0} D ( t ) {( \frac{{p}_{0}}{p} )}^{- γ} ( 1 + s \times {\sum }_{holidays} {e}_{h} h ( t ) ) & \end{matrix}$$

where SR(t,p) represents the selling rate within each week of a product as a function of time and price. Fitting the model 12 to the actual demand curve could be performed using a least squares minimization method, such as the Levenberg-Marquardt least-squares minimization approach based on MINPACK-1.

Further, constraints could be exerted on the fitting process (e.g., γ should be negative, λ₁ and λ₂ should be positive, etc.). To predict the sales volume for a product that was sold in the previous season, the fitted parameters from the demand curve of that previous season are a good starting point provided some limitations. The trend function is not likely to change drastically over the year, so λ₁ and λ₂ can be used directly without much change. However, t₀ is highly dependent on when the season actually starts. For example, if the summer of the previous season started in April, but the summer of the current season starts in May due to a long winter, a shift of 4 weeks would be added to t₀ for proper forecasting. The price elasticity γ and holiday sensitivity s are intrinsic properties of the product and should not vary significantly with time.

The selling rate constant Q₀ incorporates all other effects that are not explicitly considered in the model (e.g. the macroscopic economic situation, the life cycle of the product itself, and the price band of the product, etc.). Further, γ and Q₀ are often correlated, so that when Q₀ is large the resultant γ is usually small and vice versa. So, although the fitted γ and s are a good guess for forecasting, some experts' opinions on the general market trend should be considered for adjustments of Q₀. Also, it is possible to infer Q₀ from the sales results of some initial weeks in the season. As in any other fitting problem, the set of fitted parameters is only one of many possible solutions, and the results usually depend on the selection of the initial parameters. Consequently, the results of the model are, in principle, not the same from one year to the next, and the fitted value from the previous season would usually not be directly applicable to the future season.

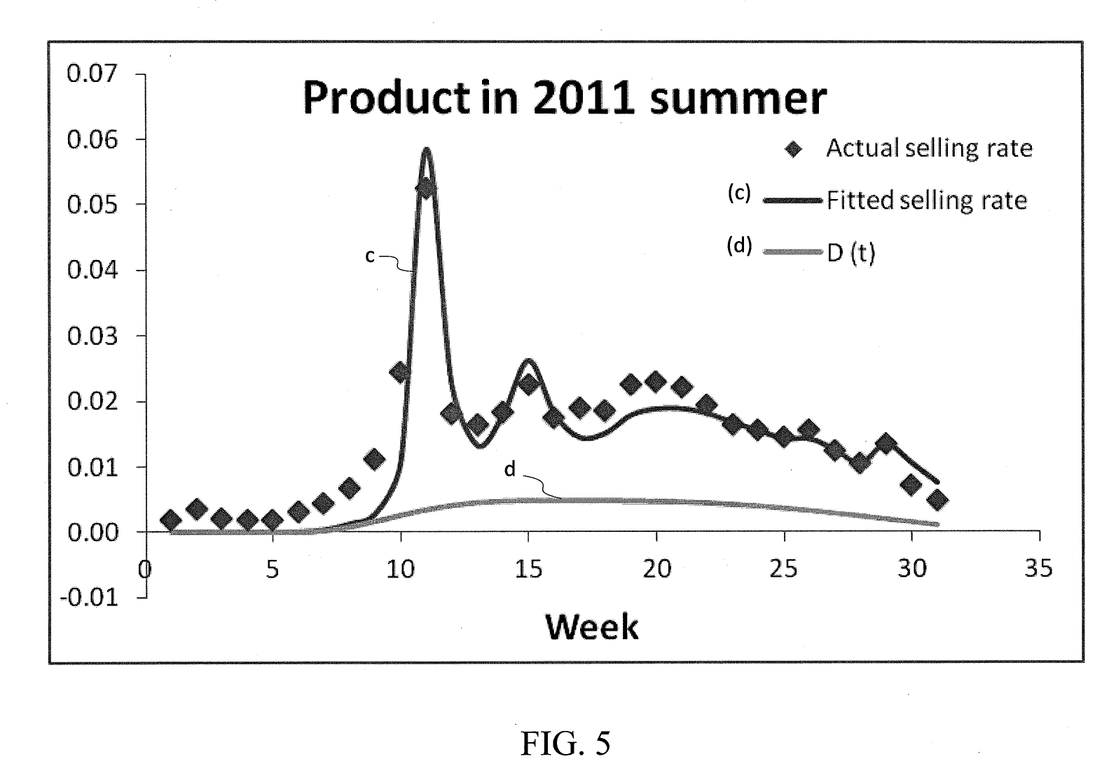

FIGS. 4-6 are graphs relating to an exemplary implementation of the system in connection with forecasting the sale of a product over the course of two summers. FIG. 4 is a graph showing a fitting result of a product sold during the summer of 2010. The actual selling rate (represented by diamonds) was calculated for each week using Equation 1. Line a is the fitted selling rate using the model, and Line b is the fitted market trend function of this product scaled with Q₀. The fitted model parameters were Q₀=0.0091, t₀=17.4, λ₁=10.07, λ₂=20.84, γ=−2.14 and s=3.45. As indicated by the graph, the fitting result is very accurate with an R-square value of 0.98, and the fitting results for other products were similarly accurate.

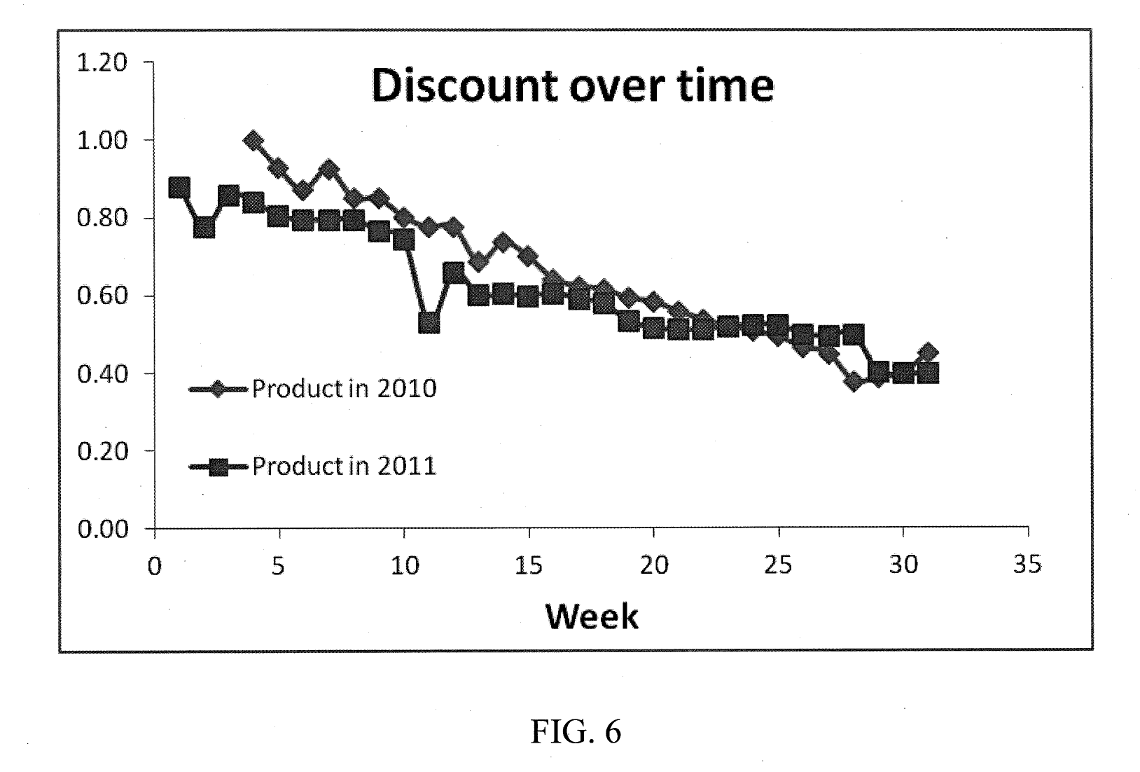

FIG. 5 is a graph showing a fitting result of the same product during the summer of 2011. The parameters used in FIG. 4 were used to predict the demand curve of the same product sold in 2011. Model parameters t₀, λ₁, λ₂, γ and s were taken from the 2010 results of FIG. 4, and Q₀=0.0047 was adjusted using the actual demand curve for 2011. The diamonds show the calculated selling rate for the same product within each week of 2011, line d is the same market trend curve as obtained above from the fitting results of the 2010 demand curve in FIG. 4, and line c is the predicted selling rate using the same market trend and adjusted Q₀. The R-square of the fitted result for the initial guess was 0.84, which is particularly impressive considering the price strategy and holiday promotions were different for those two years. FIG. 6 shows the differing price strategies (i.e., discount curves) for the same product for 2010 and 2011. In 2010 there was only a sizable promotion during a holiday in the 10^{th} week (eₕ˜0.65) while in 2011 there were promotions during holidays in the 11^{th} week (eₕ˜1) and 15^{th} week (eₕ˜0.25). The eₕ of the holiday in 2010 was set to 0.65 since the promotion in 2010 was of a smaller scope than that of 2011. The prediction shows that price elasticity and holiday sensitivity are rather consistent over the course of the year.

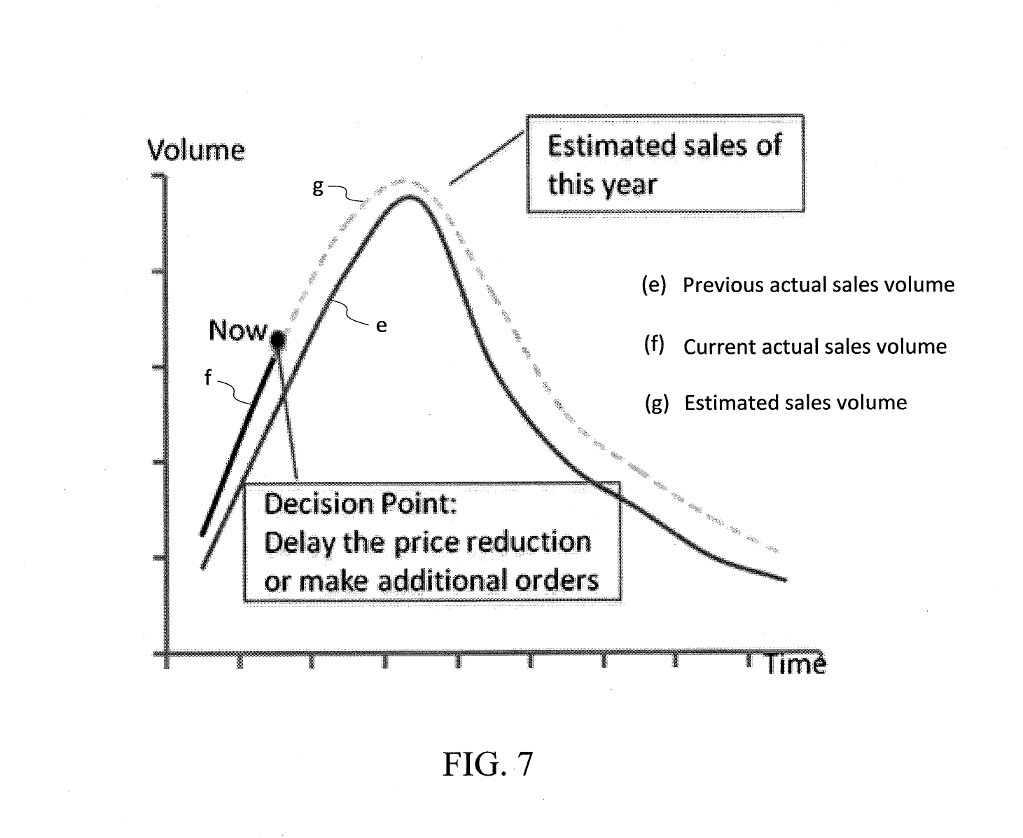

FIG. 7 shows hypothetical previous, current, and estimated sales volumes. Such data could be used for price optimization in the executing and adjusting stages. Once the modeling parameters are available, the actual sales volume can be reproduced by applying the execution factors to the selling rate, i.e., multiplying the selling rate by the number of shops and the number of flow days. The sales curve can then be used to optimize the purchase plan and improve the inventory management in advance, and optimize the pricing strategy during operation. Thus, the forecasting results can be used as a guide for price adjustments. To provide a real-time quantitative solution for price optimization, the modeling results can be used directly or the Markov Decision Process (MDP) could be utilized.

To use the modeling results directly for price optimization, a set of possible pricing strategies could be devised, and then fed into the model to get the predicted sales volumes, revenues, and profits. The optimal pricing strategy would be the one with the best combination of volume, revenue, and profits. The advantages of this approach are easy implementation, early determination of best pricing strategy for easy operations, and the best pricing strategy found is usually the global best. However, the modeling parameters may not be completely accurate before the actual sales begin, so that the chosen strategy is essentially a static solution which does not take advantage of the incoming data.

The MDP provides a mathematical framework for decision-making problems where the outcome has a random component and a component that is under the control of the decision maker. A necessary component of the MDP solution is a priori knowledge about the response of the market to certain actions (e.g., sales volume result when the discount is reduced by 20%). This is precisely the type of information the demand forecasting model provides, so that the modeling results can be combined with the MDP framework to provide a pricing optimization solution. This comprises a dynamic solution taking into account the newest data available, which relies on the modeling results but also considers the randomness of the market.

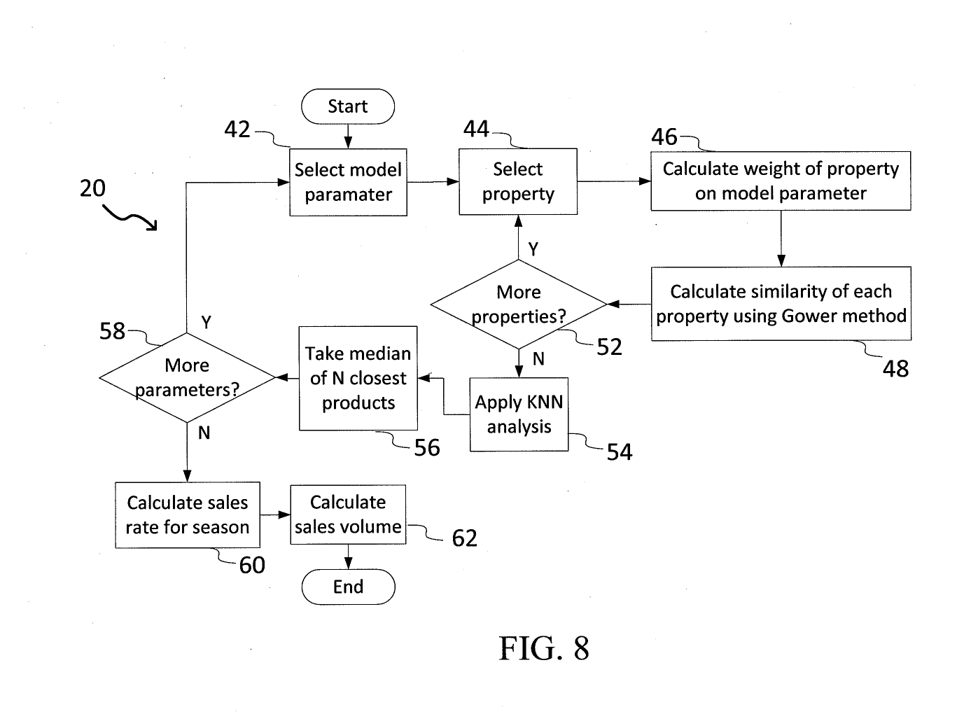

FIG. 8 is a flowchart illustrating processing steps carried out by the system for conducting a K-Nearest-Neighbor (KNN) analysis to calculate a demand forecast for a new product. In many industries (e.g., fashion and retail industry), many products are fashion or fashion-like goods without historical sales records, which can be described by their physical properties and other derived properties. For example, shoes can be described by the materials of the shoes (e.g., leather, fabrics, etc.), the heel type (e.g., high heel or low heel), initial price, on shelf date, etc. The assumption of KNN analysis is that if two products share the same key characteristics their model parameters should be similar if not the same (i.e., more characteristics the products share, the more likely their parameters would be the same). To get an initial estimate of the model parameters to forecast the demand for a brand new product, KNN analysis is performed on the intrinsic properties of the products.

In step 42 a model parameter is selected, and in step 44 a property of the product is selected. Since some of the properties are numerical while some are characteristic, the Gower method is used to calculate the similarity:

s₁(x,y)=Σⱼ₌₁^{v}wⱼδ_{x,y}^{j}d_{x,y}^{j}/Σⱼ₌₁^{v}wⱼδ_{x,y}^{j} (8)

d_{x,y}^{j}=1−|xⱼ−yⱼ| (9)

Equations 8 and 9

where δ_{x,y}^{j} is 1 for a nominal, ordinal, interval or ratio variable, and wⱼ is the weight of the j-th variable. In step 46, the weights of the variables are determined by estimating the correlation between the property and the model parameter. The properties with a significant impact on the different model parameters are assumed to not necessarily be the same (e.g., properties 1 and 2 might be more important to Q₀, and properties 2 and 3 are more important to t₀). The similarity of the property is then calculated using the Gower method in step 48. Alternatively, the similarities between products could be calculated using the PROC DISTANCE procedure in the commercially-available Statistical Analysis System (SAS) software package. This procedure computes various measures of dissimilarity or similarity between observations (i.e., rows) of a data set. The procedure also provides various nonparametric and parametric methods for standardizing variables.

In step 52, a determination is made as to whether there are more properties. If there are more properties, the process repeats at step 44. In this way, a step-wise regression is performed on the model parameter using all the properties to select the most influential ones. In step 54, KNN analysis is applied where the contribution of each property to the total R square (i.e., the partial R square) is used as the weight for that property in the KNN analysis. The ones not selected are given the weight of zero. In step 56, for a target product, N styles/products (usually 20) which are closest to it are chosen, where the median of the model parameter of the N reference products is then used as an initial estimate for the target product. In step 58, a determination is made as to whether there are more parameters to calculate. If there are, the process repeats from step 42, so that step-wise regression is performed on each of the model parameters, among other considerations. Note that KNN analysis is performed on each of the model parameters and the weighting scheme used is usually not the same.

If there are no more parameters to calculate, in step 60 the sales rate for an entire season is calculated using the estimated initial model parameters. In step 62, from the definition of the selling rate, the sales volume is then calculated (i.e., multiplying the selling rate with the number of shops and the number of flow days). For forecasting, shop numbers can be obtained from the client's sales plan for the new season, and the number of flow days can be obtained by assuming an expected number of out-of-stock rate (e.g., assuming an out-of-stock rate around 20% then the number of flow days in a week is 7*(1-20%)=5.6).

As mentioned above with respect to FIG. 1, a self-adjusting mechanism 22 could be incorporated into the demand forecasting model 10. It is anticipated that modeling parameters could be monitored and rapidly adjusted with new sales data to improve the accuracy of the forecasting because initial modeling parameters are usually not completely accurate. To accomplish this, the modeling parameters are adjustable with limited data points. One approach is to fit the available data points and update the modeling parameters accordingly. However, the variations of the market trend functions (D(t)) are generally not large and some (e.g., 3-5) data points representative of market trend functions can be extracted. Therefore, the market trend function of a product could be identified (e.g., through historical records or KNN analysis) and the parameters of D(t) held fixed, thereby leaving only three free parameters in the model. Moreover, the seasons do not usually have big holiday promotions so that holiday sensitivity s can often be omitted. With only Q₀ and γ free, the number of data points needed to adjust the model is significantly reduced. Even when the market trend function of the product is suspect, the limited number of possible trend functions leaves a small manageable number of options (e.g., 3-5) for forecasting.

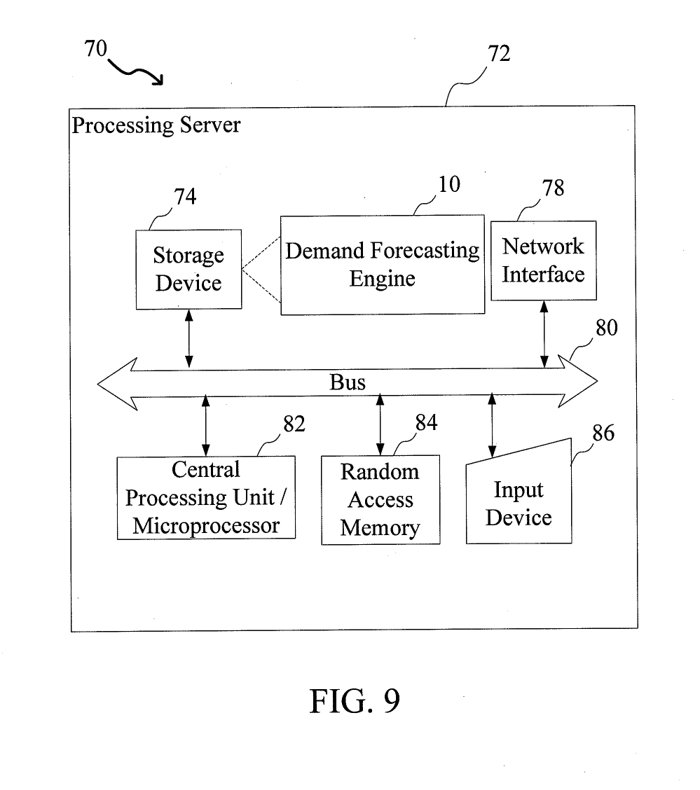

FIG. 9 is a diagram showing hardware and software components of a computer system 70 capable of performing the processes discussed in FIGS. 1-8 above. The system 70 (computer) comprises a processing server 72 which could include a storage device 74, a network interface 78, a communications bus 80, a central processing unit (CPU) (microprocessor) 82, a random access memory (RAM) 84, and one or more input devices 86, such as a keyboard, mouse, etc. The server 72 could also include a display (e.g., liquid crystal display (LCD), cathode ray tube (CRT), etc.). The storage device 74 could comprise any suitable, computer-readable storage medium such as disk, non-volatile memory (e.g., read-only memory (ROM), eraseable programmable ROM (EPROM), electrically-eraseable programmable ROM (EEPROM), flash memory, field-programmable gate array (FPGA), etc.). The server 72 could be a networked computer system, a personal computer, a smart phone, etc.

The engine 10 could be embodied as computer-readable program code stored on the storage device 74 and executed by the CPU 82 using any suitable, high or low level computing language, such as Java, C, C++, C#, .NET, MATLAB, Python, etc. The network interface 78 could include an Ethernet network interface device, a wireless network interface device, or any other suitable device which permits the server 72 to communicate via the network. The CPU 82 could include any suitable single- or multiple-core microprocessor of any suitable architecture that is capable of implementing and running the secure document distribution program 76 (e.g., Intel processor). The random access memory 84 could include any suitable, high-speed, random access memory typical of most modern computers, such as dynamic RAM (DRAM), etc.

Having thus described the invention in detail, it is to be understood that the foregoing description is not intended to limit the spirit or scope thereof. It will be understood that the embodiments of the present invention described herein are merely exemplary and that a person skilled in the art may make any variations and modification without departing from the spirit and scope of the invention. All such variations and modifications, including those discussed above, are intended to be included within the scope of the invention. What is desired to be protected is set forth in the following claims.

What is claimed is:

1. A system for demand forecasting comprising:
a computer system;
a demand forecasting engine executed by the computer system for inventory management and price optimization, the forecasting engine including:
a time series model for demand forecasting of an old product that identifies and projects a past market trend of time series data to forecast a future market trend; and
a K-Nearest Neighbor model for demand forecasting of a new product, the K-Nearest Neighbor model applies K-Nearest Neighbor analysis on a model parameter and a property, and calculates a sales volume for a new product based on results of the K-Nearest Neighbor analysis.

2. The system of claim 1, wherein the time series model processes execution factors, pricing/discount factors, and market factors.

3. The system of claim 1, wherein the demand forecasting engine develops the time series model by:
defining a selling rate to represent the demand such that a selling rate of a certain product within a given period is the number of products sold per shop per day with stock;
incorporating price elasticity of demand by determining characteristics of the new product and its target population;
profiling all demand curves for products for the years of interest; and
modeling a marketing trend incorporating seasonal factors and holiday sensitivity.

4. The system of claim 1, wherein the similarity of the property is calculated using a Gower method or PROC DISTANCE procedure.

5. The system of claim 1, wherein pricing strategies are input into the time series model, and the time series model outputs the predicted sales volumes, revenues, and profits for each pricing strategy.

6. The system of claim 1, further comprising a self-adjusting mechanism that monitors and rapidly adjusts modeling parameters based on new sales data.

7. The system of claim 1, wherein the K-Nearest Neighbor model estimates a correlation between the model parameter and property, and calculates a similarity of the property to the modeling parameter.

8. The system of claim 1, wherein the K-Nearest Neighbor model further calculates a sales rate for the new product.

9. The system of claim 1, wherein the K-Nearest Neighbor model applies K-Nearest Neighbor analysis on a plurality of properties and a plurality of model parameters.

10. A method for demand forecasting comprising:
executing on a computer system a demand forecasting engine for inventory management and price optimization;
executing a time series model of the demand forecasting engine for demand forecasting of an old product that, when executed, identifies and projects a past market trend of time series data to forecast a future market trend; and
executing a K-Nearest Neighbor model of the demand forecasting engine for demand forecasting of a new product, which, when executed, applies K-Nearest Neighbor analysis on a model parameter and a property, and calculates a sales volume for a new product based on results of the K-Nearest Neighbor analysis.

11. The method of claim 10, wherein the time series model processes execution factors, pricing/discount factors, and market factors.

12. The method of claim 10, wherein the demand forecasting engine develops the time series model by:
defining a selling rate to represent the demand such that a selling rate of a certain product within a given period is the number of products sold per shop per day with stock;
incorporating price elasticity of demand by determining characteristics of the new product and its target population;
profiling all demand curves for products for the years of interest; and
modeling a marketing trend incorporating seasonal factors and holiday sensitivity.

13. The method of claim 10, wherein the similarity of the property is calculated using a Gower method or PROC DISTANCE procedure.

14. The method of claim 10, further comprising inputting pricing strategies into the time series model, and outputting by the time series model of sales volumes, revenues, and profits for each pricing strategy.

15. The method of claim 10, further comprising executing a self-adjusting mechanism that monitors and rapidly adjusts modeling parameters based on new sales data.

16. The method of claim 10, wherein the K-Nearest Neighbor model estimates a correlation between the model parameter and property, and calculates a similarity of the property to the modeling parameter.

17. The method of claim 10, wherein the K-Nearest Neighbor model further calculates a sales rate for the new product.

18. The method of claim 10, wherein the K-Nearest Neighbor model applies K-Nearest Neighbor analysis on a plurality of properties and a plurality of model parameters.

19. A computer-readable medium having computer-readable instructions stored thereon which, when executed by a computer system, cause the computer system to perform the steps of:
executing on a computer system a demand forecasting engine for inventory management and price optimization;
executing a time series model of the demand forecasting engine for demand forecasting of an old product that, when executed, identifies and projects a past market trend of time series data to forecast a future market trend; and
executing a K-Nearest Neighbor model of the demand forecasting engine for demand forecasting of a new product, which, when executed, applies K-Nearest Neighbor analysis on a model parameter and a property, and calculates a sales volume for a new product based on results of the K-Nearest Neighbor analysis.

20. The computer-readable medium of claim 19, wherein the time series model processes execution factors, pricing/discount factors, and market factors.

21. The computer-readable medium of claim 19, wherein the demand forecasting engine develops the time series model by:
defining a selling rate to represent the demand such that a selling rate of a certain product within a given period is the number of products sold per shop per day with stock;
incorporating price elasticity of demand by determining characteristics of the new product and its target population;
profiling all demand curves for products for the years of interest; and
modeling a marketing trend incorporating seasonal factors and holiday sensitivity.

22. The computer-readable medium of claim 19, wherein the similarity of the property is calculated using a Gower method or PROC DISTANCE procedure.

23. The computer-readable medium of claim 19, further comprising inputting pricing strategies into the time series model, and outputting by the time series model of sales volumes, revenues, and profits for each pricing strategy.

24. The computer-readable medium of claim 19, further comprising executing a self-adjusting mechanism that monitors and rapidly adjusts modeling parameters based on new sales data.

25. The computer-readable medium of claim 19, wherein the K-Nearest Neighbor model estimates a correlation between the model parameter and property, and calculates a similarity of the property to the modeling parameter.

26. The computer-readable medium of claim 19, wherein the K-Nearest Neighbor model further calculates a sales rate for the new product.

27. The computer-readable medium of claim 19, wherein the K-Nearest Neighbor model applies K-Nearest Neighbor analysis on a plurality of properties and a plurality of model parameters.
